(19) United States
(12) Patent Application Publication
(10) Pub. No.: US 2011/0274050 A1
(43) Pub. Date: Nov. 10, 2011

(54) WIRELESS COMMUNICATION BASE STATION APPARATUS, WIRELESS COMMUNICATION TERMINAL DEVICE AND WIRELESS COMMUNICATION METHOD

(75) Inventors: Akiyoshi Monma, Miyagi (JP); Daisuke Tomishima, Ishikawa (JP)

(73) Assignee: PANASONIC CORPORATION

(21) Appl. No.: 13/144,664

(22) PCT Filed: Nov. 12, 2009
(86) PCT No.: PCT/JP2009/006043

§ 371 Date: Jul. 14, 2011

(30) Foreign Application Priority Data
Feb. 4, 2009 (JP) 2009-023667

(51) Int. Cl. H04W 4/00

(52) U.S. Cl. 370/328

(57) ABSTRACT

A wireless communication base station apparatus which reduces the power consumed by UE in communication using VoIP when in a silent state; and a wireless communication terminal device and wireless communication method of the same. A residual amount control unit (104) is provided with a MCS table where MCS index values are linked to modulation type and coding rate, and are further linked to DCI deletion information. Based on the MCS table and the wireless resource allocation results outputted from the control unit (103), in cases when silent information frames are continuing, the residual amount control unit (104) searches for DCI deletion information for deleting the DCI for a number of frames that is less than the number of frames of silent information, and controls the residual amount of the transmitted data so that the MCS index values linked to the detected DCI deletion information can be selected. The selected MCS index values are notified to the UE.

### TECHNICAL FIELD

The present invention relates to a wireless communication base station apparatus to which VoIP (Voice over IP) is applied, a wireless communication terminal apparatus and a wireless communication method.

### BACKGROUND ART

In 3GPP LTE (3rd Generation Partnership Project Long Term Evolution), a frame format made of DCI (Downlink Control Information) and SCH (Shared Channel) is decided in downlink (DL) from a base station to a terminal (which will be referred to as “UE” below) as shown in FIG. 1. The DCI stores therein control data for a plurality of UEs and the SCH stores therein data for a plurality of UEs. A frame length is represented as TTI (Transmission Time Interval), and is 1 ms, for example.

For 3GPP LTE, there are considered two methods in which a base station schedules a radio resource to a UE. The one is dynamic scheduling and the other is persistent scheduling. The scheduling methods will be described below. The DL format of LTE does not depend on the scheduling methods and is common therebetween.

In the dynamic scheduling, as shown in FIG. 2, a base station transmits DCI to a UE per TTI, and the UE decodes the DCI transmitted from the base station per TTI, and if UE-directed information is present in the decoded DCI, decodes UE-directed SCH from a frame containing the UE-directed DCI based on the information.

On the other hand, in the persistent scheduling, as shown in FIG. 3, a base station transmits DCI to a UE at a constant interval (DCI transmission interval) longer than TTI, and the UE decodes the DCI transmitted from the base station at the constant interval and decodes UE-directed SCH received during the DCI transmission interval based on the decoded DCI. It is decided that the persistent scheduling is applied to VoIP in 3GPP LTE.

In VoIP communication, the use of a radio resource during silence can cause a reduction in efficiency of utilization of radio resources. Thus, Non-Patent Literature discloses therein a technique in which when a silent state is continuing until next DCI transmission, a base station transmits parameter RB assignment (SCH radio resource information of each UE) multiplexed on DCI as 0, thereby improving efficiency of utilization of a radio resource.

### CITATION LIST

### Non-Patent Literature

NPL 1
Phillips, NXP, “PDCCH message information content for persistent scheduling,” 3GPP TSG RAN WG1 Meeting #53, Kansas City, USA, 5th-9 May 2008, R1-082039

### SUMMARY OF INVENTION

### Technical Problem

However, in the technique disclosed in the aforementioned Non-Patent Literature 1, even when the UE is not receiving the SCH due to the silent state, the UE needs to decode the DCI (see FIG. 4). There is a problem that the UE has to extract its necessary information from among a large number of items of information contained in the decoded DCI, which causes an increase in power consumption of the UE.

The present invention has been made in terms of the problem, and it is an object of the present invention to provide a wireless communication base station apparatus that reduces power consumption of a UE in a silent state, a wireless communication terminal apparatus and a wireless communication method in VoIP communication.

### Solution to Problem

A wireless communication base station apparatus according to the present invention comprises: a storage section that temporarily stores transmission data; and a residual amount control section that stores deletion information for deleting control information in association with a modulation and coding scheme index representing a combination of a modulation scheme and a coding rate to be applied to the transmission data, and, when silent information continues, controls the residual amount of transmission data stored in the storage section so as to select the modulation and coding scheme index corresponding to the deletion information.

A wireless communication terminal apparatus according to the present invention comprises: a reception decision section that stores deletion information for deleting control information in association with a modulation and coding scheme index representing a combination of a modulation scheme and a coding rate to be applied to transmission data, and decides whether next control information can be received based on a modulation and coding scheme index transmitted from a wireless communication base station apparatus; and a control information demodulation section that, when it is decided that the control information cannot be received, stops demodulating the control information.

A wireless communication method according to the present invention comprises: a residual amount control step of controlling a residual amount of transmission data so as to select a modulation and coding scheme index corresponding to deletion information when silent information continues based on information in which the modulation and coding scheme index representing a combination of a modulation scheme and a coding rate to be applied to the transmission data is associated with the deletion information for deleting control information; a transmission step of transmitting the selected modulation and coding scheme index to a communication party; a reception decision step of deciding whether next control information can be received based on the modulation and coding scheme index transmitted from the communication party; and a control information demodulation step of, when it is decided that the control information cannot be received, stopping demodulating the control information.

### ADVANTAGEOUS EFFECTS OF INVENTION

According to the present invention, it is possible to reduce power consumption of a UE in a silent state in VoIP communication.

### BRIEF DESCRIPTION OF DRAWINGS

FIG. 1 shows a frame format in 3GPP LTE;

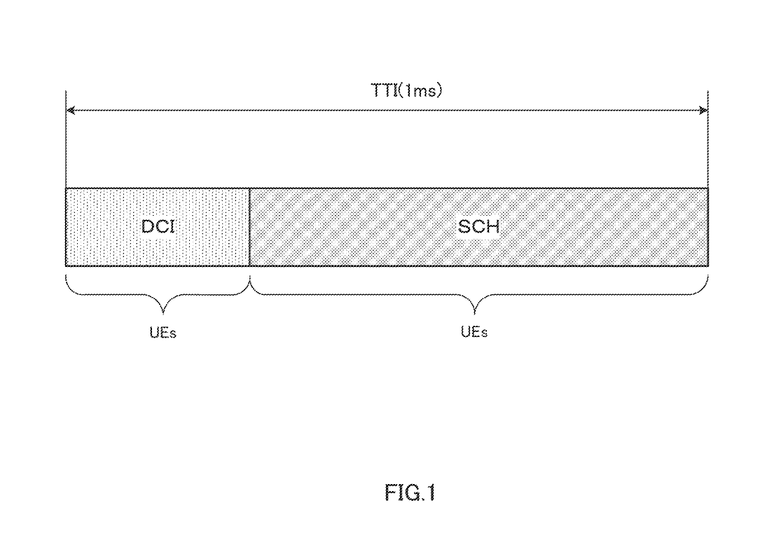

FIG. 2 explains dynamic scheduling;

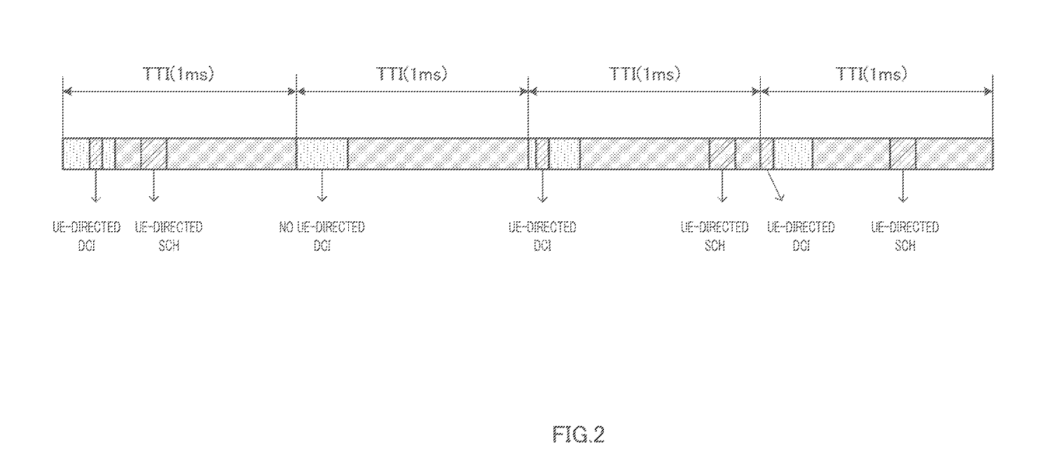

FIG. 3 explains persistent scheduling;

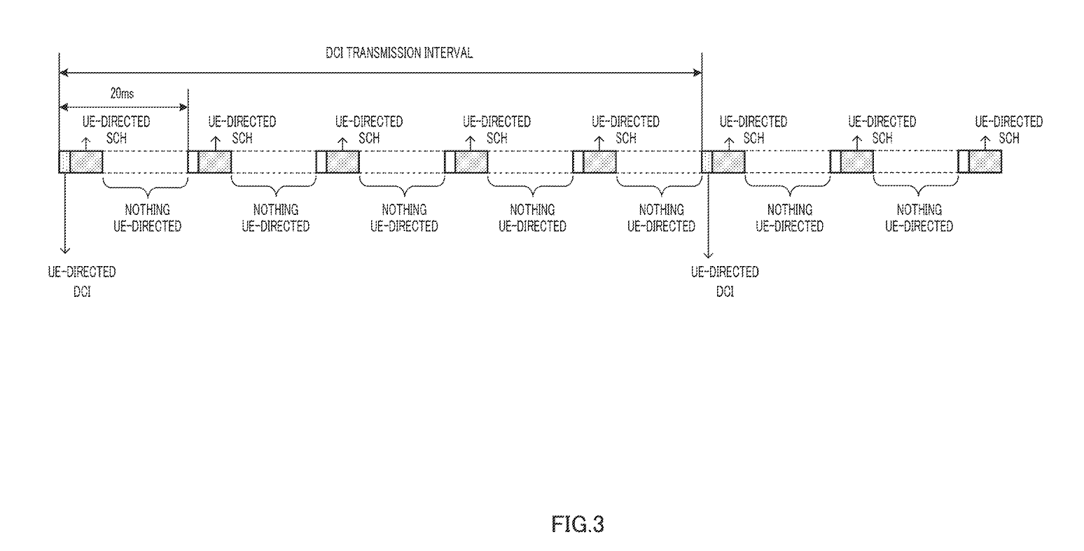

FIG. 4 explains problems;

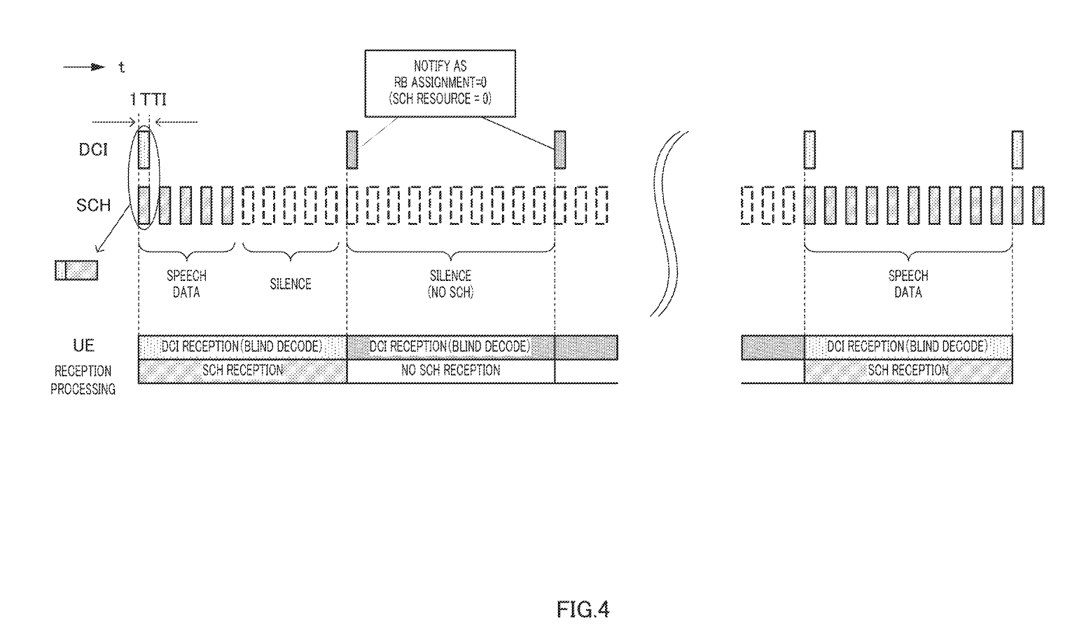

FIG. 5 is a block diagram showing a structure of a base station according to Embodiments 1 and 2 of the present invention;

FIG. 6 shows an exemplary MCS table according to Embodiment 1 of the present invention;

FIG. 7 is a block diagram showing a structure of a UE according to Embodiments 1 and 2 of the present invention;

FIG. 8 explains residual amount control of transmission data in the base station shown in FIG. 5;

FIG. 9 is a diagram illustrating an exemplary MCS table according to Embodiment 2 of the present invention; and

FIG. 10 explains residual amount control using the MCS table shown in FIG. 9.

### DESCRIPTION OF EMBODIMENTS

Embodiments of the present invention will be described below in detail with reference to the drawings.

### Embodiment 1

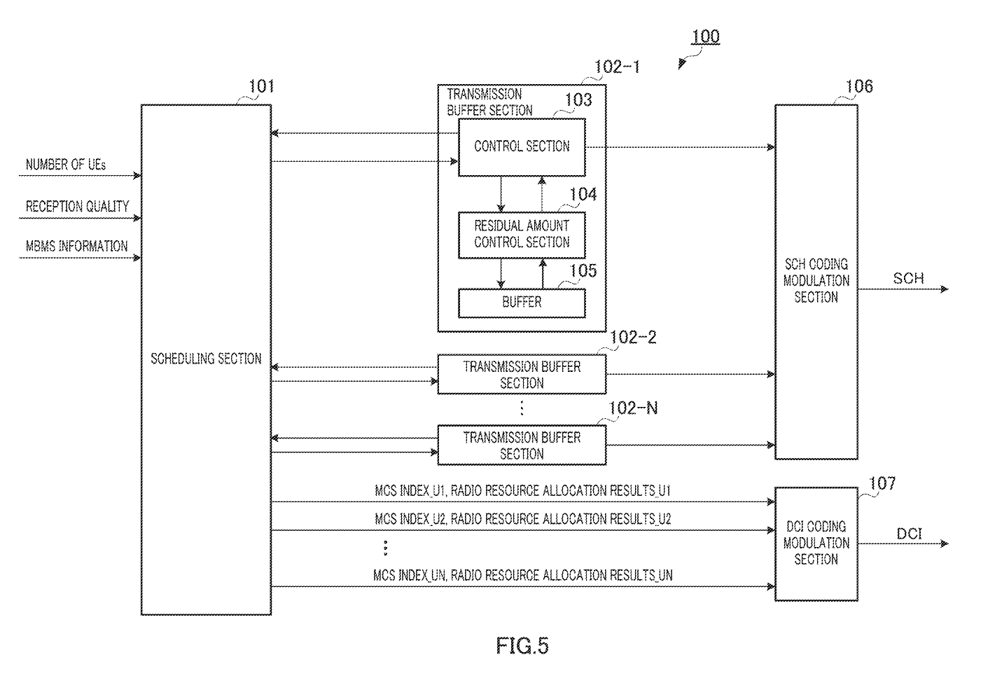

FIG. 5 is a block diagram showing a structure of base station 100 according to Embodiment 1 of the present invention. In the Figure, scheduling section 101 acquires the number of UEs under the base station, a reception quality of a signal transmitted from a UE, and MBMS (Multimedia Broadcast Multicast Service) information from a control section and others (not shown). Scheduling section 101 further acquires the amount of transmission data transmitted from transmission buffer sections 102-1 to 102-N described later to each UE under the base station. Scheduling section 101 allocates radio resources based on the acquired information, and outputs the radio resource allocation results to transmission buffer sections 102-1 to 102-N and DCI coding modulation section 107, respectively.

Scheduling section 101 comprises a MCS (Modulation and Coding Scheme) table, decides a MCS to be allocated to each UE based on the acquired information and the MCS table, and outputs an index indicating the decided MCS (MCS index) to DCI coding modulation section 107. The details of the MCS table will be described later.

Transmission buffer sections 102-1 to 102-N correspond to the UEs one by one under the base station, buffer the transmission data to be transmitted to the UEs, and notifies scheduling section 101 of the amount of transmission data to be transmitted to the UEs. Transmission buffer sections 102-1 to 102-N output the transmission data to SCH coding modulation section 106 based on the radio resource allocation results outputted from scheduling section 101. Transmission buffer sections 102-1 to 102-N have the same structure and thus an description will be made by way of transmission buffer section 102-1. Transmission buffer section 102-1 comprises control section 103, residual amount control section 104 and buffer 105.

Control section 103 outputs the amount of transmission data, which is subjected to residual amount control, outputted from residual amount control section 104 described later, and outputs the transmission data outputted from residual amount control section 104 to SCH coding modulation section 106. Control section 103 outputs the radio resource allocation results outputted from scheduling section 101 to residual amount control section 104.

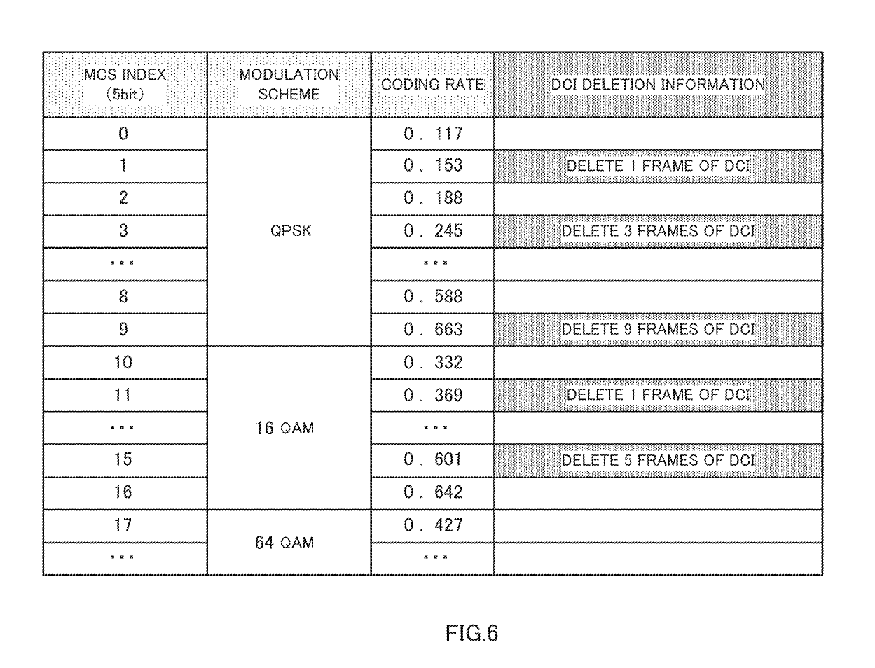

Residual amount control section 104 comprises the same MCS table as the MCS table provided in scheduling section 101. The MCS table will be described herein. As shown in FIG. 6, MCS indices are linked to a modulation scheme and a coding rate, and further linked to DCI deletion information. The DCI deletion information is information for notifying that unnecessary DCI is not transmitted while a silent state is continuing, that is, the number of frames for which the DCI is to be deleted. Residual amount control section 104 searches for the DCI deletion information by which the DCI for the number of frames less than the number of frames for the silent information is to be deleted when the silent information frames are continuing on the basis of the MCS table and the radio resource allocation results outputted from control section 103, and controls the residual amount of transmission data so as to select the MCS indices corresponding to the searched DCI deletion information. Then, the transmission data amount subjected to the residual amount control is notified to control section 103. Residual amount control section 104 outputs a buffer address after the residual amount control to buffer 105.

Buffer 105 temporarily stores the data to be transmitted to the UEs therein, and outputs the transmission data to residual amount control section 104 according to the buffer address outputted from residual amount control section 104.

SCH coding modulation section 106 codes and modulates the transmission data outputted from transmission buffer sections 102-1 to 102-N, and transmits it to the UEs.

DCI coding modulation section 107 codes and modulates the radio resource allocation results outputted from scheduling section 101 and the MCS indices, and transmits the same to the UEs.

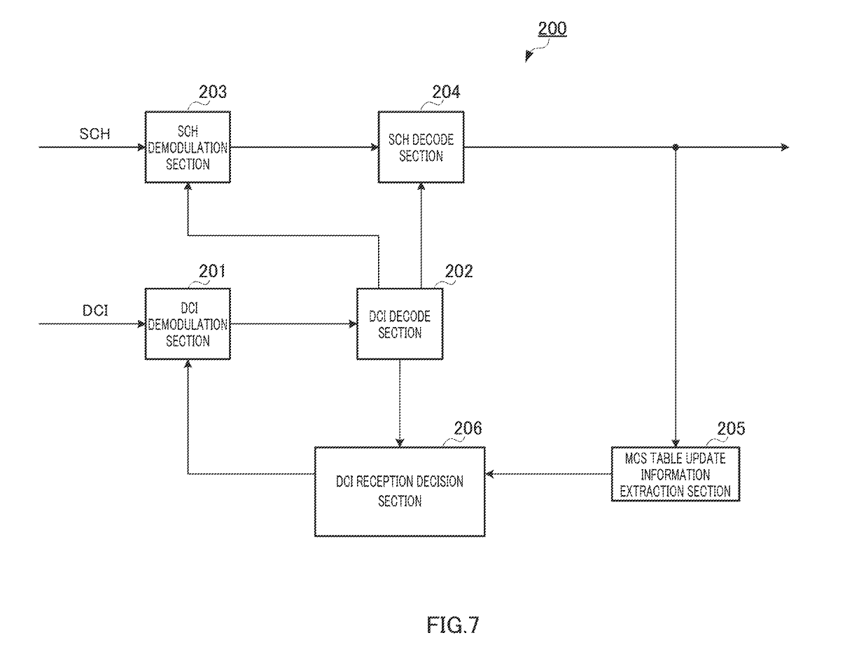

FIG. 7 is a block diagram showing a structure of UE 200 according to Embodiment 1 of the present invention. In the Figure, when acquiring reception enable indicating an enabled reception from DCI reception decision section 206 described later, DCI demodulation section 201 demodulates DCI transmitted from base station 100, and when acquiring reception disable indicating a disabled reception from DCI reception decision section 206, does not demodulate the DCI. The demodulated DCI is outputted to DCI decode section 202.

DCI decode section 202 decodes the DCI outputted from DCI demodulation section 201, and acquires the radio resource allocation results and the MCS indices. The acquired radio resource allocation results are outputted to SCH demodulation section 203, and the MCS indices are outputted to SCH decode section 204 and DCI reception decision section 206.

SCH demodulation section 203 demodulates the SCH transmitted from the base station based on the radio resource allocation results outputted from DCI decode section 202, and outputs the demodulated SCH to SCH decode section 204.

SCH decode section 204 decodes the SCH outputted from SCH demodulation section 203 according to the MCS indices outputted from DCI decode section 202, and outputs the decode result. The decode result may contain MCS table update information for updating the correspondence relationship between the MCS indices and the DCI deletion information, and the decode result is outputted to MCS table update information extraction section 205.

MCS table update information extraction section 205 detects whether the MCS table update information is contained in the decode result outputted from SCH decode section 204, and when the MCS table update information is contained therein, extracts the MCS table update information from the decode result and outputs it to DCI reception decision section 206.

DCI reception decision section 206 comprises the MCS table as shown in FIG. 6, and when the MCS table update information is outputted from MCS table update information extraction section 205, updates the MCS table. DCI reception decision section 206 decides whether next DCI to be transmitted from the base station can be received based on the MCS indices outputted from DCI decode section 202 and the MCS table. When it is decided that the DCI can be received, reception enable is generated and outputted to DCI demodulation section 201, and when it is decided that the DCI cannot be received, reception disable is generated and outputted to DCI demodulation section 201.

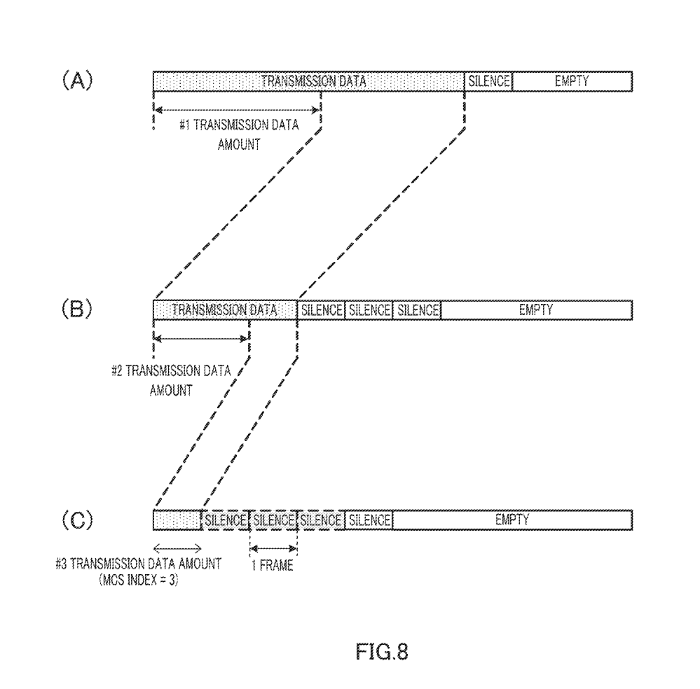

Next, the residual amount control of the transmission data in base station 100 shown in FIG. 5 will be described in detail with reference to FIG. 8. FIG. 8 shows how the transmission data stored in buffer 105 is, where time elapses at interval of TTI (corresponding to two frames) from FIG. 8(A) to FIG. 8(C). When the state of FIG. 8(A) transits to the state of FIG. 8(C), three frames of silent information are continuing and thus residual amount control section 104 refers to the MCS table shown in FIG. 6 and controls the residual amount of transmission data so as to select MCS index 3 corresponding to the DCI deletion information for deleting three frames of DCI. In other words, since MCS index 3 is linked to the modulation scheme QPSK and the coding rate of 0.245, the residual amount needs to be controlled to the data amount transmittable by the MCS.

In FIG. 8(C), buffer 105 in the base station deletes the three frames of silent information, and DCI demodulation section 201 in UE 200 stops demodulating the three frames (1.5 TTI) of DCI after receiving MCS index 3.

By this means, the silent state continuing time can be notified to UE 200 without adding new signaling from base station 100 to UE 200, and UE 200 stops demodulating the DCI only during the notified continuing time, thereby reducing power consumption.

According to Embodiment 1, the DCI deletion information is linked to the MCS table, and when the silent state is continuing, the silent state continuing time is notified by the MCS index from the base station to the UE, and the UE stops demodulating the DCI only during the silent state continuing time, thereby reducing power consumption in VoIP communication.

### Embodiment 2

The structures of a base station and a UE according to Embodiment 2 of the present invention are similar to the structures shown in FIGS. 5 and 7 according to Embodiment 1, respectively, and thus will be described with reference to FIG. 5 and FIG. 7.

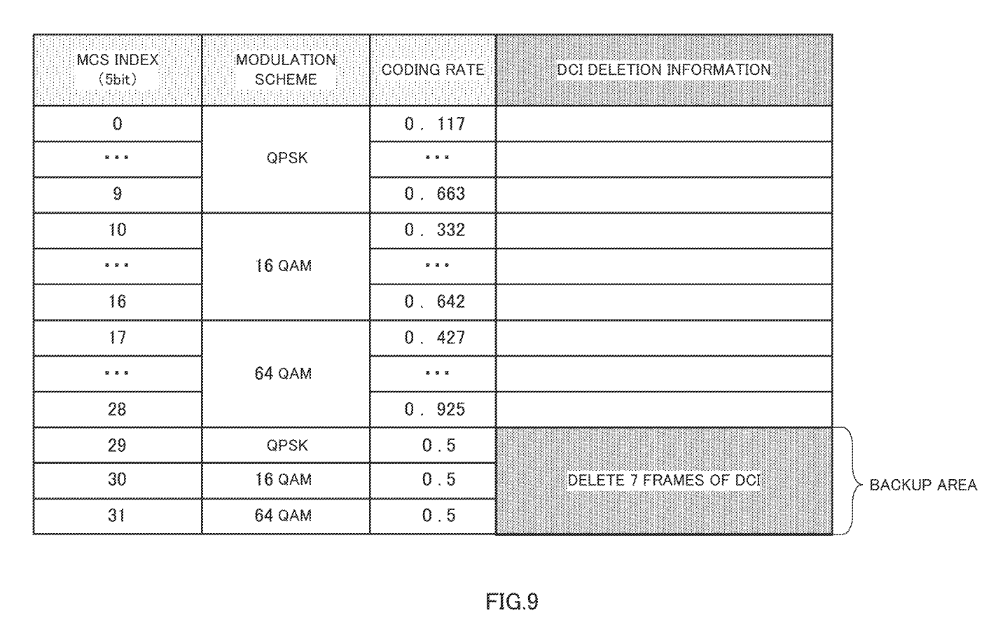

FIG. 9 shows an exemplary MCS table according to Embodiment 2 of the present invention. In the present embodiment, the indices linked to the DCI deletion information are assumed as a backup area of the MCS table. In the example of FIG. 9, the DCI deletion information is in association with MCS indices 29 to 31.

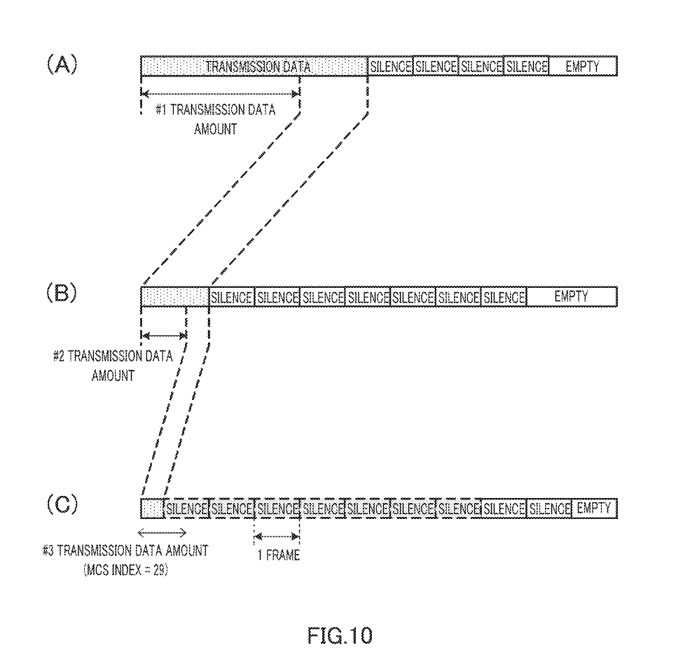

Next, the residual amount control using the MCS table shown in FIG. 9 will be described in detail with reference to FIG. 10. FIG. 10 shows how the transmission data stored in the buffer is, where time elapses at interval of TTI from FIG. 10(A) to FIG. 10(C).

When the state of FIG. 10(A) transits to the state of FIG. 10(B), seven frames of silent information are continuing and thus residual amount control section 104 refers to the MCS table shown in FIG. 9 and controls the residual amount of transmission data so as to select MCS index 29 corresponding to the DCI deletion information for deleting seven frames of DCI.

In FIG. 10(C), buffer 105 in the base station deletes the seven frames of silent information, and DCI demodulation section 201 in UE 200 stops demodulating the seven frames (7TTI) of DCI after receiving MCS index 29.

According to Embodiment 2, the DCI deletion information is linked to the MCS table, and when the silent state is continuing, the silent state continuing time is notified by the MCS indices from the base station to the UE, and the UE stops demodulating the DCI only during the silent state continuing time, thereby reducing power consumption of the UE in VoIP communication.

The deletion of the seven frames of DCI has been described in the present embodiment, but the present invention is not limited thereto and may only be set so as to delete two or more frames of DCI.

The disclosure of Japanese Patent Application No. 2009-023667, filed on Feb. 4, 2009, including the specification, drawings and abstract, is incorporated herein by reference in its entirety.

### INDUSTRIAL APPLICABILITY

The wireless communication base station apparatus, the wireless communication terminal apparatus and the wireless communication method according to the present invention can be applied to a mobile communication system such as 3GPP LTE.

1. A wireless communication base station apparatus comprising:
a storage section that temporarily stores transmission data; and
a residual amount control section that stores deletion information for deleting control information in association with a modulation and coding scheme index representing a combination of a modulation scheme and a coding rate to be applied to the transmission data, and, when silent information continues, controls the residual amount of transmission data stored in the storage section so as to select the modulation and coding scheme index corresponding to the deletion information.

2. The wireless communication base station apparatus according to claim 1, wherein the residual amount control section stores information associated with the deletion information in a modulation and coding scheme index backup area.

3. The wireless communication base station apparatus according to claim 1, wherein the residual amount control section commands to delete silent information stored in the storage section.

4. A wireless communication terminal apparatus comprising:
a reception decision section that stores deletion information for deleting control information in association with a modulation and coding scheme index representing a combination of a modulation scheme and a coding rate to be applied to transmission data, and decides whether next control information can be received based on a modulation and coding scheme index transmitted from a wireless communication base station apparatus; and
a control information demodulation section that, when it is decided that the control information cannot be received, stops demodulating the control information.

5. The wireless communication terminal apparatus according to claim 4, further comprising an extraction section that extracts update information which is contained in transmission data which is transmitted from the wireless communication base station apparatus and which updates deletion information from the transmission data, wherein the reception decision section uses the extracted update information to update the deletion information associated with the modulation and coding scheme index.

6. A wireless communication method comprising:
a residual amount control step of controlling a residual amount of transmission data so as to select a modulation and coding scheme index corresponding to deletion information when silent information continues based on information in which the modulation and coding scheme index representing a combination of a modulation scheme and a coding rate to be applied to the transmission data is associated with the deletion information for deleting control information;
a transmission step of transmitting the selected modulation and coding scheme index to a communication party;
a reception decision step of deciding whether next control information can be received based on the modulation and coding scheme index transmitted from the communication party; and
a control information demodulation step of, when it is decided that the control information cannot be received, stopping demodulating the control information.
